(19) United States
(12) Patent Application Publication
(10) Pub. No.: US 2023/0099359 A1
(43) Pub. Date: Mar. 30, 2023

(54) Inertial Sensor Module

(71) Applicant: SEIKO EPSON CORPORATION, Tokyo (JP)

(72) Inventor: Shinichi MITSUNAGA, Shiojiri (JP)

(21) Appl. No.: 17/955,589

(22) Filed: Sep. 29, 2022

(30) Foreign Application Priority Data
Sep. 30, 2021 (JP) 2021-160807

(51) Int. Cl. G01P 15/08; G01P 15/18

(52) U.S. Cl. CPC G01P 15/0888; G01P 15/18; G01P 15/0802

(57) ABSTRACT

An inertial sensor module includes a first sensor, a second sensor, and a processing circuit. The first sensor detects, with a first sensitivity, a first physical quantity at a first detection axis and a second physical quantity at a second detection axis. The second sensor detects, with a second sensitivity different from the first sensitivity, a third physical quantity at a third detection axis with a higher accuracy than the first sensor. The processing circuit performs arithmetic processing that is processing of converting the first physical quantity and the second physical quantity at the first sensitivity and the third physical quantity at the second sensitivity into a first physical quantity, a second physical quantity, and a third physical quantity at a predetermined sensitivity.

The present application is based on, and claims priority from JP Application Serial Number 2021-160807, filed Sep. 30, 2021, the disclosure of which is hereby incorporated by reference herein in its entirety.

### BACKGROUND

### 1. Technical Field

The present disclosure relates to an inertial sensor module.

### 2. Related Art

JP-A-2016-031358 discloses that a three-axis angular velocity sensor and a three-axis acceleration sensor, in each of which a movable member or the like made of silicone is formed, are formed on a substrate of a host device.

However, specifications such as sensitivity may differ depending on a sensor. Therefore, when a plurality of sensors with different sensitivities are mounted on the substrate of a host device, an adjustment to uniform the sensitivity or the like on a host device side becomes complicated.

### SUMMARY

One aspect of the present disclosure relates to an inertial sensor module, the inertial sensor module includes a first sensor configured to detect, with a first sensitivity, a first physical quantity at a first detection axis and a second physical quantity at a second detection axis; a second sensor configured to detect, with a second sensitivity different from the first sensitivity, a third physical quantity at a third detection axis with a higher accuracy than the first sensor; and a processing circuit configured to perform processing of converting the first physical quantity and the second physical quantity at the first sensitivity and the third physical quantity at the second sensitivity into a first physical quantity, a second physical quantity, and a third physical quantity at a predetermined sensitivity.

### BRIEF DESCRIPTION OF THE DRAWINGS

FIG. 1 is a block diagram showing a configuration example of an embodiment.

FIG. 2 is a diagram illustrating an example of a relation between a detection range and a first scale factor.

FIG. 3 is a flowchart illustrating a processing example of arithmetic processing.

FIG. 4 is a flowchart illustrating a processing example of sensitivity correction.

FIG. 5 is a diagram illustrating an example of a second scale factor.

FIG. 6 is a block diagram illustrating a modification of the present embodiment.

FIG. 7 is a diagram illustrating a relation of a first input rate, a second input rate, and a predetermined output rate.

FIG. 8 is a timing chart illustrating a method of the modification.

FIG. 9 is another timing chart illustrating the method of the modification.

FIG. 10 is a block diagram illustrating another modification of the present embodiment.

FIG. 11 is a diagram illustrating a relation of a first detection axis, a second detection axis, and a third detection axis.

FIG. 12 is a diagram illustrating an example of a problem in a detection error of a third physical quantity.

### DESCRIPTION OF EXEMPLARY EMBODIMENTS

Hereinafter, a preferred embodiment of the disclosure will be described in detail. The present embodiment to be described below does not unduly limit contents described in the claims, and not all configurations described in the present embodiment are necessarily essential constituent elements.

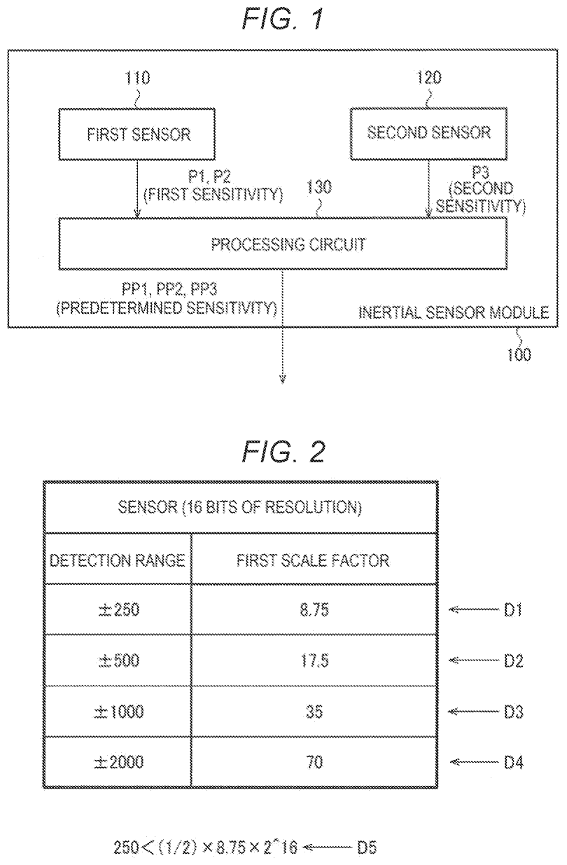

FIG. 1 is a block diagram showing a configuration example of an inertial sensor module 100 according to the present embodiment. The inertial sensor module 100 according to the present embodiment includes a first sensor 110, a second sensor 120, and a processing circuit 130.

The first sensor 110 detects a physical quantity in an X-axis direction that is, for example, a first detection axis as a first physical quantity P1 with a first sensitivity. Similarly, the first sensor 110 detects a physical quantity in a Y-axis direction that is a second detection axis as a second physical quantity P2 with the first sensitivity. The first sensitivity will be described below. Although not shown in FIG. 1, the first sensor 110 includes a sensor element for detecting a physical quantity at an X axis or a Y axis and an analog circuit including an amplifier circuit or the like that amplifies a detection signal from the sensor element, and the first sensor 110 outputs an analog signal from the analog circuit. In addition, although similarly not shown in FIG. 1, the first sensor 110 may further include, for example, an A/D conversion circuit that converts the analog signal from the analog circuit into digital data. Thus, the first sensor 110 can output output data of the A/D conversion circuit or digital data obtained by performing correction processing such as temperature correction on the output data. In addition, the number of bits of the A/D conversion circuit provided in the first sensor 110 is defined as the first number of bits. The first sensor 110 may be able to detect physical quantities in the X-axis direction and the Y-axis direction by using one sensor element, and may be provided with a sensor element that detects the physical quantity in the X-axis direction and a sensor element that detects the physical quantity in the Y-axis direction. The digital data may be simply referred to as data in the following description. In addition, in the following description, the digital data transmitted by the first sensor 110 or the first physical quantity P1 and the second physical quantity P2 obtained by multiplying the digital data by the first number of bits may be collectively referred to as first sensor data. The same applies to modifications to be described later.

The physical quantity is, for example, an acceleration, and may be an angular velocity or another physical quantity. For example, when the physical quantity is an acceleration, the first sensor 110 is a two-axis acceleration sensor, and can be implemented by a device, for example, a capacitive Si-MEMS sensor device capable of detecting accelerations in the X-axis direction and the Y-axis direction. The first sensor 110 is not limited to the above, and may be implemented by a frequency change type crystal acceleration sensor, a piezo resistance type acceleration sensor, or a heat detection type acceleration sensor. For example, when the physical quantity is an angular velocity, the first sensor 110 is a two-axis angular velocity, and for example, can be implemented by an Si-MEMS sensor device, and also may be implemented by, for example, a resonance frequency change type crystal angular velocity sensor that is made of crystal and detects an angular velocity from a Coriolis force applied to a vibrating object. The angular velocity sensor is also referred to as a gyro sensor.

The second sensor 120 detects a physical quantity in a Z-axis direction that is, for example, a third detection axis as a third physical quantity P3 with a second sensitivity. The second sensitivity will be described below. Although not shown in FIG. 1, the second sensor 120 includes a sensor element for detecting a physical quantity at a Z axis and an analog circuit including an amplifier circuit or the like that amplifies a detection signal from the sensor element, and the second sensor 120 outputs an analog signal from the analog circuit. In addition, although similarly not shown in FIG. 1, the second sensor 120 may further include, for example, an A/D conversion circuit that converts the analog signal from the analog circuit into digital data. Thus, the second sensor 120 can output output data of the A/D conversion circuit or digital data obtained by performing correction processing such as temperature correction on the output data. In addition, the number of bits of the A/D conversion circuit provided in the second sensor 120 is defined as the second number of bits. The second sensor 120 can be implemented by various sensors similarly to the first sensor, and specifications such as a sensitivity are different from those of the first sensor 110. In addition, in the following description, digital data transmitted by the second sensor 120 or the third physical quantity P3 obtained by multiplying the digital data by the second number of bits may be collectively referred to as second sensor data. The same applies to the modifications to be described later.

In the following description, a detection axis in a direction parallel to the X axis may be referred to as the first detection axis, a detection axis in a direction parallel to the Y axis is referred to as the second detection axis, and a detection axis in a direction parallel to the Z axis is referred to as the third detection axis. In addition, X-axis physical quantity data output by the first sensor 110 may be referred to as the first physical quantity P1, and Y-axis physical quantity data may be referred to as the second physical quantity P2. In addition, similarly, Z-axis physical quantity data output by the second sensor 120 may be referred to as the third physical quantity P3. An angular velocity around the first detection axis may be referred to as a first angular velocity G1, an angular velocity around the second detection axis may be referred to as a second angular velocity G2, and an angular velocity around the third detection axis may be referred to as a third angular velocity G3. In addition, an acceleration around the first detection axis may be referred to as a first acceleration A1, an acceleration around the second detection axis may be referred to as a second acceleration A2, and an acceleration around the third detection axis may be referred to as a third acceleration A3. As described above, the first sensor 110 detects, with the first sensitivity, the first physical quantity P1 at the first detection axis, and the second physical quantity P2 at the second detection axis. The second sensor 120 detects the third physical quantity P3 at the third detection axis with the second sensitivity.

The processing circuit 130 performs processing of parts in the inertial sensor module 100. For example, the processing circuit 130 performs processing of controlling the first sensor 110, the second sensor 120, and the like. For example, when the first sensor 110 and the second sensor 120 are digital physical quantity sensors, the processing circuit 130 is a controller that communicates with the first sensor 110 and the second sensor 120 by digital data and becomes a master for the first sensor 110 and the second sensor 120. The processing circuit 130 is implemented by the following hardware. The hardware includes a circuit that processes a digital signal, and may further include a circuit that processes an analog signal. For example, the hardware can be implemented by one or more circuit devices mounted on a circuit board and one or more circuit elements. The one or more circuit devices are, for example, integrated circuits (IC), and field-programmable gate arrays (FPGA). The one or more circuit element are, for example, resistors, and capacitors. Further, the processing circuit 130 includes at least one of the following processors. The processing circuit 130 includes a memory (not shown in FIG. 1) for storing information and a processor that operates based on the information stored in the memory. The information is, for example, a program and various data. The processor includes hardware. The processor may use various processors such as a central processing unit (CPU), a graphics processing unit (GPU), and a digital signal processor (DSP). The memory may be a semiconductor memory such as a static random access memory (SRAM) or a dynamic random access memory (DRAM), and may be a register, a magnetic storage device such as a hard disk drive (HDD), or may be an optical storage device such as an optical disk device. For example, the memory stores an instruction that can be read by a computer, and when the instruction is executed by the processor, functions of a part or all of the parts in the processing circuit 130 are implemented as processing. The instruction here may be an instruction of an instruction set constituting a program, or an instruction instructing an operation to a hardware circuit of the processor.

Next, the first sensitivity and the second sensitivity will be described. The sensitivity refers to a change in an output amount per unit of a physical quantity input to a physical quantity sensor, and is also referred to as a gain. In addition, a degree of the sensitivity is referred to as a sensitivity coefficient or a scale factor SF. For example, it is assumed that when a plurality of analog acceleration sensors are compared, the scale factor SF is shown in units such as [mV/g]. Here, g is an acceleration value with respect to standard gravity. In this case, when the same physical quantity is input to sensor elements of respective acceleration sensors, the acceleration sensor that outputs a high voltage value has a larger scale factor SF, that is, is an acceleration sensor with a high sensitivity. Further, the scale factor SF may also be shown in units of an opposite dimension of such as [g/mV]. When the physical quantity sensor is a digital acceleration sensor, for example, since an analog output voltage value is A/D converted by the above-mentioned A/D conversion circuit, the scale factor SF is shown in units of such as [g/LSB] or [LSB/g]. That is, the sensitivity is related to the first number of bits and the second number of bits.

In the following description, a representative value of the scale factor SF shown in a data sheet is referred to as a first scale factor SF1, and a temperature dependence is not considered. In addition, in the following description, the first scale factor SF1 of the first sensor 110 is denoted as SF11, the first scale factor SF1 of the second sensor 120 is denoted as SF12, and the first scale factor SF1 of the inertial sensor module 100 is denoted as SF1P. In addition, the first scale factor SF1P of the inertial sensor module 100 may be referred to as a predetermined scale factor SF1P.

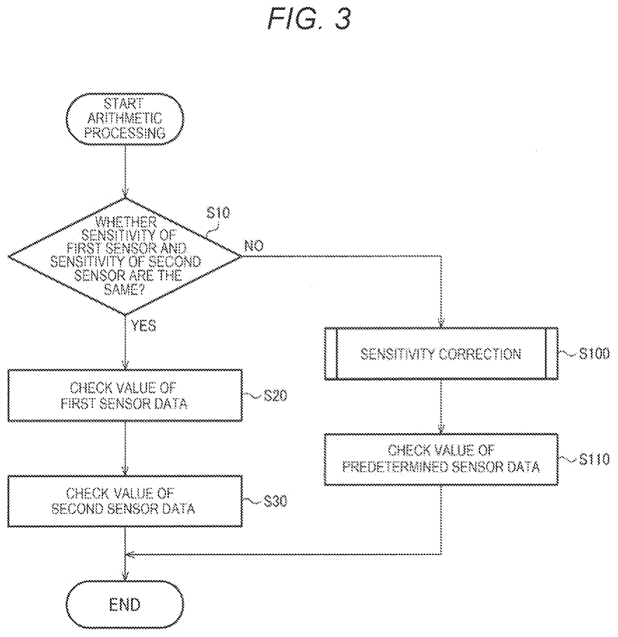

In addition, the sensitivity is also related to a detection range. The detection range is also referred to as a full scale or a rating, but is not an absolute rating. For example, it is assumed that in a data sheet of a digital physical quantity sensor, the first scale factor SF1 is shown as D1, D2, D3, and D4 in FIG. 2. Further, in FIG. 2, a particular unit is omitted. For example, when the first scale factor SF1 shown by D1 is multiplied by 16 bits of resolution, as shown by D5, the multiplication result thereof may be larger than the detection range and may not coincide with the detection range. That is, when a digital value close to an upper limit value or a lower limit value of the detection range is detected, it is necessary to check whether the digital value can be used as valid data. When comparing D1 and D2 in FIG. 2, if the detection range of the physical quantity is doubled, the first scale factor SF1 is doubled. Similarly, when comparing D1 and D3, if the detection range of the physical quantity is tripled, the first scale factor SF1 is tripled, and when comparing D1 and D4, if the detection range of the physical quantity is quadrupled, the first scale factor SF1 is quadrupled. That is, if the detection range of the first sensor 110 is changed and then is used, the first scale factor SF11 is also to be changed. The same applies to the first scale factor SF12 of the second sensor 120.

In this way, when the first scale factor SF11 of the first sensor 110 and the first scale factor SF12 of the second sensor 120 are different, if the first sensor data and the second sensor data are output as they are from the inertial sensor module 100, on a device side as an output destination, it is not possible to convert the data to an accurate physical quantity unless a different conversion coefficient is prepared for each sensor. In addition, when the output first sensor data and second sensor data are converted to physical quantities on the device side as the output destination, it may be necessary to check whether the physical quantities are within the detection range.

In this regard, in the present embodiment, the processing circuit 130 performs arithmetic processing of converting the first physical quantity P1 and the second physical quantity P2 at the first sensitivity and the third physical quantity P3 at the second sensitivity into a first physical quantity PP1, a second physical quantity PP2, and a third physical quantity PP3 at a predetermined sensitivity. The arithmetic processing can be implemented by, for example, the following method. For example, it is assumed that the first sensor 110 is an analog acceleration sensor in which a value of the first scale factor SF11 is AS1 [mV/g], and the second sensor 120 is an analog acceleration sensor in which a value of the first scale factor SF12 is AS2 [mV/g]. In this case, the processing circuit 130 multiplies voltage values obtained from the first sensor 110 by a value of a second scale factor SF21 (=AS2/AS1), and outputs values as a first acceleration PA1 and a second acceleration PA2 at a predetermined sensitivity. On the other hand, the processing circuit 130 outputs a voltage value obtained from the second sensor 120 as it is as a third acceleration PA3 at the predetermined sensitivity. Thus, the inertial sensor module 100 can output the first acceleration PA1, the second acceleration PA2, and the third acceleration PA3 at the predetermined sensitivity as an acceleration sensor in which a value of the predetermined scale factor SF1P is AS2 [mV/g]. Accordingly, the inertial sensor module 100 can output acceleration data with unified sensitivity. Further, the physical quantities are described as above in the case where the first sensor 110 and the second sensor 120 are analog acceleration sensors, and the first sensor 110 and the second sensor 120 may be, for example, analog angular velocity sensors.

As described above, the inertial sensor module 100 according to the present embodiment includes the first sensor 110, the second sensor 120, and the processing circuit 130. The first sensor 110 detects the first physical quantity P1 at the first detection axis, the second physical quantity P2 at the second detection axis with the first sensitivity. The second sensor 120 detects the third physical quantity P3 at the third detection axis with a higher accuracy than that of the first sensor and with the second sensitivity different from the first sensitivity. The processing circuit 130 performs the arithmetic processing that is processing of converting the first physical quantity P1 and the second physical quantity P2 at the first sensitivity and the third physical quantity P3 at the second sensitivity to the first physical quantity PP1, the second physical quantity PP2, and the third physical quantity PP3 at the predetermined sensitivity.

Therefore, the inertial sensor module 100 according to the present embodiment can obtain the first physical quantity P1 on the first detection axis and the second physical quantity P2 on the second detection axis from the first sensor 110, and can obtain the third physical quantity P3 from the second sensor 120. Accordingly, the inertial sensor module 100 can be a three-axis physical quantity sensor. In addition, the inertial sensor module 100 according to the present embodiment includes the processing circuit 130, so that the inertial sensor module 100 can convert the first physical quantity P1 and the second physical quantity P2 at the first sensitivity and the third physical quantity P3 at the second sensitivity to the first physical quantity PP1, the second physical quantity PP2, and the third physical quantity PP3 at the predetermined sensitivity. According to methods in the related art, it is necessary for the inertial sensor module 100 to adjust the sensitivity so as to be unified on the device side to which the sensor data are to be output. In this regard, by applying a method according to the present embodiment, the adjustment can be facilitated without changing specifications on a coupling side. Further, although the third detection axis is described as the Z axis in the above description, the third detection axis may be the X axis or the Y axis. In the following description, the first physical quantity PP1, the second physical quantity PP2, and the third physical quantity PP3 at the predetermined sensitivity that are output from the processing circuit 130 may be collectively referred to as predetermined sensor data.

As described above, specifically, the physical quantity according to the present embodiment may be, for example, an angular velocity. That is, the first physical quantity P1 is the first angular velocity G1 as the angular velocity around the first detection axis, the second physical quantity P2 is the second angular velocity G2 as the angular velocity around the second detection axis, and the third physical quantity P3 is the third angular velocity G3 as the angular velocity around the third detection axis. Thus, by applying the method according to the present embodiment described above, the processing circuit 130 can output a first angular velocity PG1 at a predetermined sensitivity, a second angular velocity PG2 at a predetermined sensitivity, and a third angular velocity PG3 at a predetermined sensitivity.

Further, as described above, the physical quantity according to the present embodiment may be, for example, an acceleration. That is, the first physical quantity is the first acceleration A1 as the acceleration at the first detection axis, the second physical quantity is the second acceleration A2 as the acceleration at the second detection axis, and the third physical quantity is the third acceleration A3 as the acceleration at the third detection axis. Thus, by applying the method according to the present embodiment described above, the processing circuit 130 can output the first acceleration PA1 at a predetermined sensitivity, the second acceleration PA2 at a predetermined sensitivity, and the third acceleration PA3 at a predetermined sensitivity.

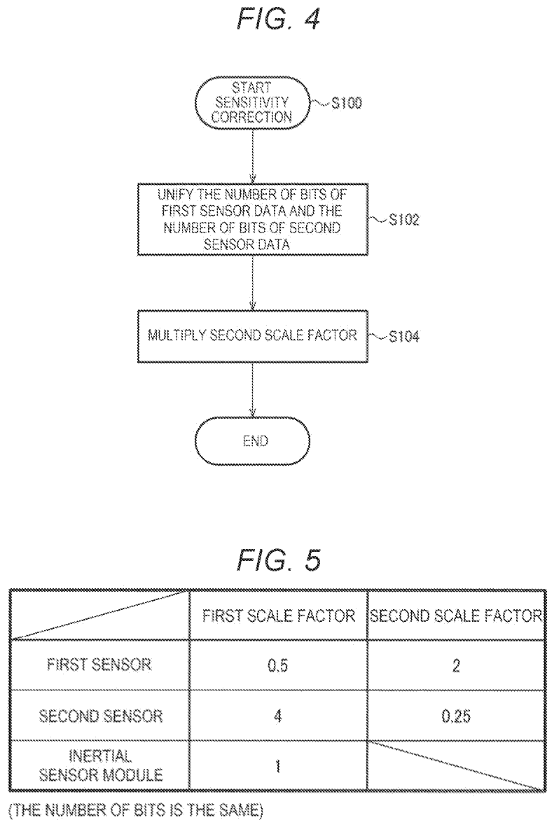

In addition, the method according to the present embodiment is not limited to the above, and various modifications can be made. For example, the method according to the present embodiment can also be applied to the case where the first sensor 110 and the second sensor 120 are digital physical quantity sensors. A processing example of the arithmetic processing in such a case will be described with reference to flowcharts of FIGS. 3 and 4. Further, it is assumed that a problem of an input/output timing is not considered in FIGS. 3 and 4. That is, it is assumed that the first sensor data and the second sensor data are input to the processing circuit 130 in synchronization with each other, and the predetermined sensor data is output at a timing after the processing of FIGS. 3 and 4. An example in which the timing is considered will be described later.

The processing circuit 130 determines whether the sensitivity of the first sensor 110 and the sensitivity of the second sensor 120 are the same (step S10). Specifically, for example, the processing circuit 130 performs processing of storing the first scale factor SF11 of the first sensor 110 and the first scale factor SF12 of the second sensor 120 into a storage unit (not shown) in advance, and compares the first scale factor SF11 and the first scale factor SF12. When the sensitivity of the first sensor 110 and the sensitivity of the second sensor 120 are the same (YES in step S10), the processing circuit 130 checks a value of the first sensor data obtained from the first sensor 110 (step S20). Specifically, for example, the processing circuit 130 performs processing of checking whether a value of the first physical quantity P1 obtained by multiplying the obtained first sensor data by the first number of bits is within the detection range. In addition, although the processing is not shown, when the value of the first physical quantity P1 is out of the detection range, the first sensor data may be fixed to a maximum value or a minimum value within the detection range and be output, or the first sensor data may not be output.

After performing the processing in step S20, the processing circuit 130 checks an obtained value of the second sensor data obtained from the second sensor 120 (step S30). Specifically, for example, the processing circuit 130 performs processing of checking whether the second physical quantity P2 obtained by multiplying the obtained second sensor data by the second number of bits is within the detection range. In addition, although the processing is not shown, when the value of the second physical quantity P2 is out of the detection range, the second sensor data may be fixed to the maximum value or the minimum value within the detection range and be output, or the second sensor data may not be output.

On the other hand, when the sensitivity of the first sensor 110 and the sensitivity of the second sensor 120 are different (NO in step S10), the processing circuit 130 performs sensitivity correction (step S100).

FIG. 4 is a flowchart showing a processing example of the sensitivity correction (step S100). The processing circuit 130 performs processing of unifying the number of bits of the first sensor data and the number of bits of the second sensor data (step S102). Specifically, for example, the processing circuit 130 performs processing of unifying the first number of bits and the second number of bits to the predetermined number of bits. The predetermined number of bits is, for example, of the first number of bits and the second number of bits, a larger number of bits, and may be different from the first number of bits and the second number of bits. For example, when the first number of bits is 15 bits, the second number of bits is 16 bits, and it is desired to unify the predetermined number of bits as 16 bits, the processing circuit 130 performs processing of converting the 15-bit first sensor data into 16-bit first sensor data, and does not perform any processing on the second sensor data. Accordingly, the first sensor data and the second sensor data are unified as 16-bit data having the predetermined number of bits. In this case, for example, the processing circuit 130 performs processing of multiplying the first sensor data by 2, and processing of multiplying the first scale factor SF11 of the first sensor 110 by ½.

Then, the processing circuit 130 performs processing (step S104) of multiplying the second scale factor SF2. Specifically, the processing circuit 130 performs processing of multiplying the first sensor data by the second scale factor SF21 and multiplying the second sensor data by a second scale factor SF22. The second scale factors SF21 and SF22 are obtained, for example, based on the following method. For example, the processing circuit 130 obtains the first scale factors SF11, SF12, and SF1P when the number of bits is unified to the predetermined number of bits. Then, the processing circuit 130 obtains the second scale factors SF21 and SF22 such that a product of the first scale factor SF11 and the second scale factor SF21 and a product of the first scale factor SF12 and the second scale factor SF22 are equal to the first scale factor SF1P. Specifically, the above is shown as in FIG. 5, for example. In FIG. 5, specific units are omitted, and specific values of the first scale factors SF11, SF12, SF1P and the second scale factors SF21, SF22 are not always as shown in FIG. 5. For example, it is assumed that the value of the first scale factor SF11 is 0.5, the value of the first scale factor SF12 is obtained as 4, and the value of the first scale factor SF1P is set to 1. In this case, the value of the second scale factor SF21 is 2, and the value of the second scale factor SF22 is obtained as 0.25. Thus, the digital inertial sensor module 100 can output the first physical quantity PP1, the second physical quantity PP2, and the third physical quantity PP3 unified by the first scale factor SF1P of the inertial sensor module 100.

Returning to FIG. 3, the processing circuit 130 checks a value of the predetermined sensor data (step S110) after performing the sensitivity correction (step S100) described above. Specifically, the processing circuit 130 obtains values of the first physical quantity PP1, the second physical quantity PP2, and the third physical quantity PP3 at the predetermined sensitivity by multiplying the predetermined sensor data after the sensitivity correction (step S100) by a predetermined number of bits. Then, the processing circuit 130 checks whether the values of the first physical quantity PP1, the second physical quantity PP2, and the third physical quantity PP3 at the predetermined sensitivity are within the detection range set in the inertial sensor module 100. In addition, although the processing is not shown, when the calculated values of the first physical quantity PP1, the second physical quantity PP2, and the third physical quantity PP3 at the predetermined sensitivity are out of the detection range, the processing circuit 130 may fix the predetermined sensor data to the maximum value or the minimum value within the detection range and output the predetermined sensor data, and may not output the predetermined sensor data.

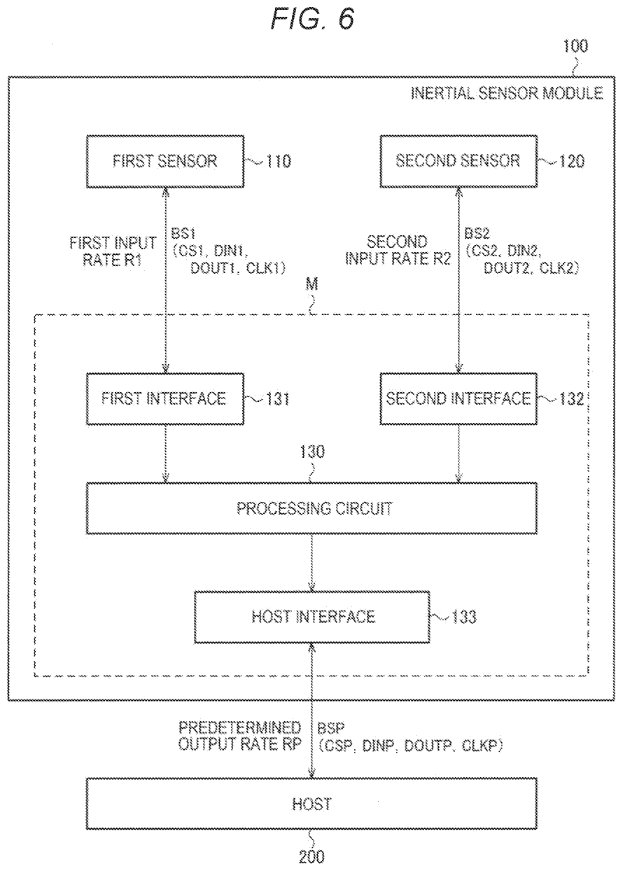

In addition, the method according to the present embodiment is not limited to the above, and various modifications can be made. For example, the inertial sensor module 100 according to the present embodiment may be configured as shown in a block diagram of FIG. 6 as a modification. The modification shown in FIG. 6 differs from the example of FIG. 1 in that the inertial sensor module 100 further includes a first interface 131, a second interface 132, and a host interface 133. For example, the processing circuit 130, the first interface 131, the second interface 132, and the host interface 133 within a dotted line indicated by M can be implemented by a microcontroller.

The first interface 131 is a circuit that performs interface processing related to transmission and reception of digital data with the first sensor 110 according to a predetermined communication method. The predetermined communication method is, for example, a predetermined serial communication method, and may be a parallel communication method. Further, the predetermined serial communication method is a synchronous serial peripheral interface (SPI), and may be an inter-integrated circuit (I2C), a universal asynchronous receiver transmitter (UART) or the like, and may be a communication method obtained by improving or modifying a part of these communication methods.

The first sensor 110 and the first interface 131 are electrically coupled by a first digital interface bus BS1. Further, the sensor data from the first sensor 110 is input to the first interface 131 via the first digital interface bus BS1. The first digital interface bus BS1 is a bus that conforms to a communication standard of the interface processing performed by the first interface 131. For example, when the first interface 131 follows the SPI, as shown in FIG. 6, the first digital interface bus BS1 includes four signal lines including a signal line CS1, a signal line DINT, a signal line DOUT1, and a signal line CLK1. In the following description, the CS1 may be used to mean both a signal line and a signal passing through the signal line. The same applies to the signal line CLK1.

The second interface 132 is a circuit that performs interface processing related to transmission and reception of digital data with the second sensor 120 according to a predetermined communication method. The predetermined communication method is as described above. The communication method followed by the second interface 132 may be the same as or different from the communication method followed by the first interface 131.

The second sensor 120 and the second interface 132 are electrically coupled by a second digital interface bus BS2. Further, the sensor data from the second sensor 120 is input to the second interface 132 via the second digital interface bus BS2. The second digital interface bus BS2 is a bus that conforms to a communication standard of the interface processing performed by the second interface 132. For example, when the second interface 132 follows the SPI, as shown in FIG. 6, the second digital interface bus BS2 includes four signal lines including a signal line CS2, a signal line DIN2, a signal line DOUT2, and a signal line CLK2. In the following description, the CS2 may be used to mean both a signal line and a signal passing through the signal line. The same applies to the signal line CLK2.

The host interface 133 is a circuit that performs interface processing related to transmission and reception of data with a host 200 to be described later according to a predetermined communication method. The predetermined communication method is as described above. The communication method followed by the host interface 133 may be the same as or different from the communication method followed by the first interface 131 or the second interface 132.

The host 200 is a device that is electrically coupled to the inertial sensor module 100 or the like and obtains the physical quantities output from the inertial sensor module 100. The host 200 includes a processing unit (not shown), and the processing unit can be implemented by a processor or the like similar to the processing circuit 130 described above. For example, the host 200 is provided in a measurement system (not shown) and controls parts of the measurement system. The measurement system can calculate a position or the like of a predetermined measurement object based on the physical quantities obtained by the host 200. The predetermined measurement object is, for example, a moving object such as a bicycle, a four-wheeled vehicle, a motorcycle, an electric train, an airplane, or a ship, or an electronic device such as a personal computer, a smartphone, a tablet terminal, a clock, a car navigation device, or various measuring devices, and is not particularly limited. For example, the measurement system includes the host 200, a GPS reception unit (not shown), and an antenna for GPS reception (not shown), so that the measurement system can calculate the position or the like of the predetermined measurement object. Specifically, the GPS reception unit receives a signal from a GPS satellite via the antenna, and the host 200 detects GPS positioning data representing a position, a speed, and a direction of the predetermined measurement object based on the signal received by the GPS reception unit. The position of the predetermined measurement object is a latitude, a longitude, an altitude, or the like. In addition, the host 200 performs inertial navigation arithmetic processing on the physical quantity data obtained from the inertial sensor module 100, and obtains inertial navigation positioning data. The inertial navigation positioning data includes acceleration data and posture data of the measurement object. Further, the host 200 calculates the position or the like of the predetermined measurement object based on the obtained inertial navigation positioning data and GPS positioning data. For example, when the predetermined measurement object is a four-wheeled vehicle, the host 200 calculates which position on the ground the four-wheeled vehicle is traveling.

The host 200 and the host interface 133 are electrically coupled by a predetermined digital interface bus BSP. Then, data from the host interface 133 is input to an interface (not shown) of the host 200 via the predetermined digital interface bus BSP. In the following description, inputting the data to the interface (not shown) of the host 200 may simply mean that the host 200 receives the data. The predetermined digital interface bus BSP is a bus that conforms to the communication standard of interface processing performed by the host interface 133 or the like. For example, when the host interface 133 follows the SPI, as shown in FIG. 6, the predetermined digital interface bus BSP includes four signal lines including a signal line CSP, a signal line DINP, a signal line DOUTP, and a signal line CLKP. In the following description, the CSP may be used to mean both a signal line and a signal passing through the signal line. The same applies to the signal line CLKP.

Further, other features may be added to a configuration example shown in FIG. 6. For example, although not shown in FIG. 6, the first sensor 110 and the processing circuit 130 may be coupled via a predetermined signal line DRDY1. Further, for example, although not shown in FIG. 6, the host 200 and the processing circuit 130 may be coupled via a signal line DRDYP. Thus, for example, the first sensor 110, which is a slave, can notify the processing circuit 130, which is a master, of the start of communication. In the following description, the DRDY1 may be used to mean both a signal line and a signal passing through the signal line. The same applies to the DRDYP.

Thus, the inertial sensor module 100 according to the present embodiment includes the first interface 131 that is an interface for the first sensor 110, the second interface 132 that is an interface for the second sensor 120, and the host interface 133 that is an interface for the host 200. Further, the host interface 133 outputs the first physical quantity PP1, the second physical quantity PP2, and the third physical quantity PP3 at the predetermined sensitivity to the host 200. Thus, the inertial sensor module 100 according to the present embodiment can perform transmission and reception of data with the first sensor 110, the second sensor 120, and the host 200 by including the first interface 131, the second interface 132, and the host interface 133. Further, the host interface 133 can output the first physical quantity PP1, the second physical quantity PP2, and the third physical quantity PP3 whose sensitivity is unified to the predetermined sensitivity to the host 200.

In the example described above, it is assumed that there is no problem regarding a timing at which the processing circuit 130 receives the first sensor data from the first sensor 110 and a timing at which the processing circuit 130 receives the second sensor data from the second sensor 120. However, according to a predetermined situation, the timing at which the processing circuit 130 receives the first sensor data from the first sensor 110 and the timing at which the processing circuit 130 receives the second sensor data from the second sensor 120 may be different. The predetermined situation is, for example, a situation where a user wants to consider a record of receiving and using the first sensor data from the first sensor 110 at a first input rate R1, and a record of receiving and using the second sensor data from the second sensor 120 at a second input rate R2. In this case, when the first input rate R1 and the second input rate R2 are different, the timing at which the processing circuit 130 receives the first sensor data and the timing at which the processing circuit 130 receives the second sensor data are not necessarily synchronized.

Although the details will be described later, the method according to the present embodiment can also be applied when the first input rate R1 and the second input rate R2 are different. That is, in the inertial sensor module 100 according to the present embodiment, the first sensor 110 inputs the first physical quantity P1 and the second physical quantity P2 at the first sensitivity to the first interface 131 at the first input rate R1, and the second sensor 120 inputs the third physical quantity P3 at the second sensitivity to the second interface 132 at the second input rate R2 different from the first input rate R1. Thus, the inertial sensor module 100 including sensors having different input rates can output the predetermined sensor data at a unified sensitivity.

In this case, although the details will be described later, the predetermined sensor data whose output rate is unified to a predetermined output rate RP is output from the host interface 133. That is, in the inertial sensor module 100 according to the present embodiment, the host interface 133 outputs the first physical quantity PP1, the second physical quantity PP2, and the third physical quantity PP3 at the predetermined sensitivity to the host 200 at the predetermined output rate RP. Thus, the inertial sensor module 100 can output the predetermined sensor data with sensitivity and output rate unified.

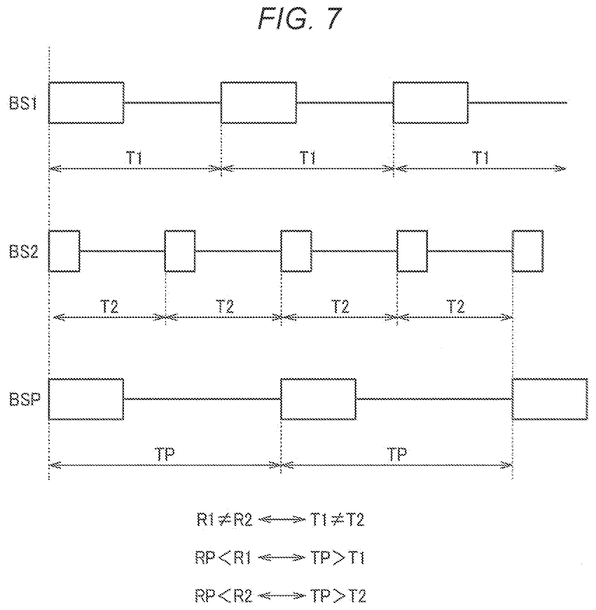

Here, an input cycle corresponding to the first input rate R1 is set to a first cycle T1, similarly, an input cycle corresponding to the second input rate R2 is set to a second cycle T2, and an output cycle corresponding to the predetermined output rate RP is set to a predetermined cycle TP. At this time, as shown in FIG. 7, it is assumed that the first cycle T1 is shorter than the predetermined cycle TP, the second cycle T2 is shorter than the predetermined cycle TP, and the first cycle T1 is different from the second cycle T2. That is, in the inertial sensor module 100 according to the present embodiment, the predetermined output rate RP is lower than the first input rate R1 and the second input rate R2. Thus, since the predetermined cycle TP on an output side can be made longer than the first cycle T1 and the second cycle T2 on an input side, the first sensor data and the second sensor data on the input side can be output in synchronization with each other. In FIG. 7, the predetermined cycle TP is shown as being twice the second cycle T2, but does not have to be twice the second cycle T2.

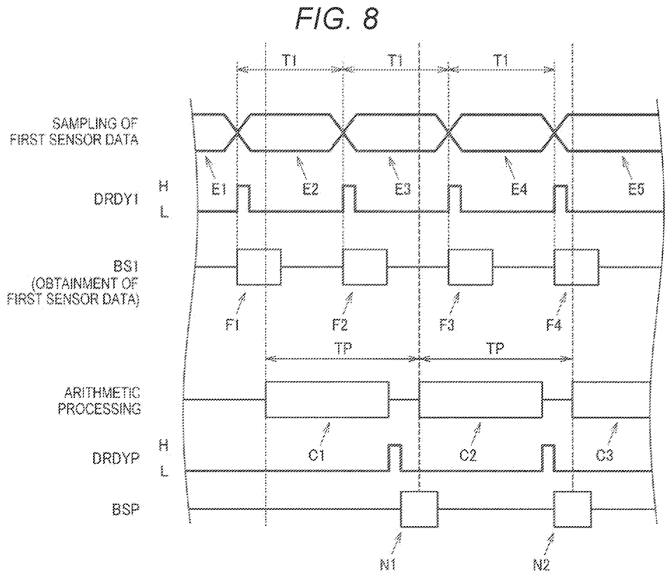

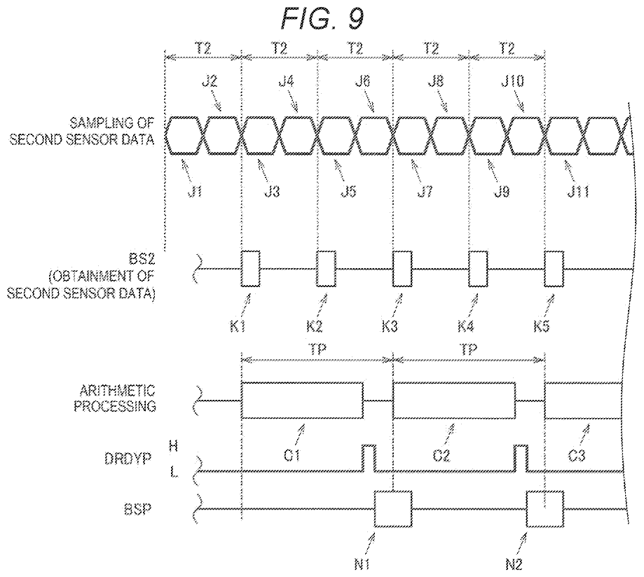

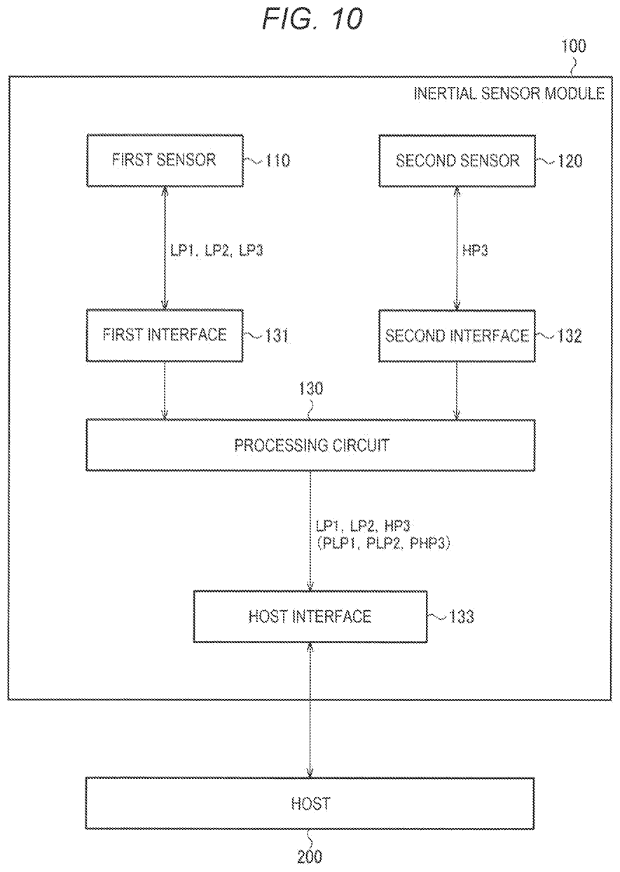

A specific method for outputting the first physical quantity PP1, the second physical quantity PP2, and the third physical quantity PP3 at the predetermined sensitivity to the host 200 at the predetermined output rate RP will be described using timing charts of FIGS. 8 and 9. FIG. 8 is a timing chart that shows a relation of the data passing through the first digital interface bus BS1, the arithmetic processing in the processing circuit 130, and the data passing through the predetermined digital interface bus BSP. Further, a timing for the arithmetic processing, the signal DRDYP, and the predetermined digital interface bus BSP shown in FIG. 8 is the same as a timing for the arithmetic processing, the signal DRDYP, and the predetermined digital interface bus BSP shown in FIG. 9.

As shown in FIG. 8, the first sensor 110 samples the first sensor data by a sensor element (not shown) in the first cycle T1, as indicated by E1, E2, E3, E4, and E5. In addition, the first sensor 110 sets the signal DRDY1 described above to an H level in the first cycle T1, and thus the first interface 131, which is a master, obtains the first sensor data from the first sensor 110, which is a slave. Accordingly, as indicated by F1, F2, F3, and F4, data transmission of the first sensor data is performed via the first digital interface bus BS1 in the first cycle T1. More specifically, although not shown, the first interface 131 sets the signal CS1 of negative logic to an L level since the signal DRDY1 is at the H level. Further, the first interface 131 transmits data to the first sensor 110 via the signal line DOUT1 in synchronization with the signal CLK1, and receives the first sensor data via the signal line DIN1. That is, the signal CLK1 is based on the processing circuit 130 or an oscillation circuit (not shown) provided in the first interface 131, and the first cycle T1, which is an input cycle of the first sensor data, is based on an oscillation circuit (not shown) on a first sensor 110 side.

The processing circuit 130 performs the arithmetic processing based on the obtained first sensor data and the second sensor data that is not shown in FIG. 8. Specifically, as indicated by C1 and C2, the processing circuit 130 performs the arithmetic processing in the predetermined cycle TP. The first sensor data used for the arithmetic processing is based on latest obtained data. For example, the arithmetic processing indicated by C2 is performed using the first sensor data obtained by data obtainment indicated by F2, that is, the first sensor data obtained by sampling indicated by E2.

As indicated by K1, K2, K3, K4, and K5 in FIG. 9, the second interface 132, which is a master, obtains the second sensor data from the second sensor 120, which is a slave, in the second cycle T2. More specifically, although not shown, the second interface 132 sets the signal CS2 to an L level every second cycle T2. Further, the second interface 132 receives the second sensor data via the signal line DIN2 in synchronization with the signal CLK2, and transmits data to the second sensor 120 via the signal line DOUT2. That is, the signal CLK2 is based on the processing circuit 130 or an oscillation circuit (not shown) provided in the second interface 132, and the second cycle T2, which is an input cycle of the second sensor data, is also based on the oscillation circuit. Therefore, the oscillation circuit on which the predetermined cycle TP described above is based on may be the same as the oscillation circuit on which the second cycle T2 is based on, and the predetermined output rate RP described above may be implemented by dividing a frequency from the oscillation circuit on which the second input rate R2 is based on. Further, the data transmitted via the signal line DOUT2 is do-not-care data.

As indicated by J1, J2, J3, J4, J5, J6, J7, J8, J9, J10, and J11 in FIG. 9, the second sensor 120 can sample the second sensor data at a cycle shorter than the second cycle T2. In FIG. 9, the second cycle T2 is shown as being twice the sampling cycle, but does not have to be twice the sampling cycle. At this time, for example, the obtainment of the second sensor data indicated by K1 is performed so as to obtain an average value of the second sensor data obtained by sampling indicated by J1 and J2. Further, the second sensor data used for the arithmetic processing described in FIG. 8 is based on latest obtained data. That is, for example, in the arithmetic processing indicated by C2, data in the obtainment indicated by K3, that is, an average value of the second sensor data sampled by J5 and J6 is used. Similarly, for example, in the arithmetic processing indicated by C3, data in the obtainment indicated by K5, that is, an average value of the second sensor data sampled by J9 and J10 is used.

As indicated by N1 and N2, the processing circuit 130 outputs the predetermined sensor data for each predetermined cycle TP. Specifically, the processing circuit 130 sets the signal DRDYP to an H level each time the arithmetic processing is completed. Accordingly, the host 200, which is a master, transmits data to the host interface 133, which is a slave, and receives data. More specifically, although not shown, the host 200 sets the signal CSP of negative logic to an L level since the signal DRDYP is at the H level. Then, the host 200 transmits data to the host interface 133 via the signal line DOUTP in synchronization with the signal CLKP, and receives the predetermined sensor data after the arithmetic processing, that is, the first physical quantity PP1, the second physical quantity PP2, and the third physical quantity PP3 at the predetermined sensitivity via the signal line DINP. That is, the signal CLKP is based on an oscillator circuit (not shown) provided in the host 200, and the predetermined cycle TP, which is the output cycle from the host interface 133, is based on the processing circuit 130 or an oscillation circuit provided in the host interface 133. Further, the data transmitted via the signal line DOUTP is do-not-care data. For example, the predetermined sensor data indicated by N2 is based on the arithmetic processing indicated by C2, and thus the predetermined sensor data, which is obtained by performing the arithmetic processing on the first sensor data obtained by sampling indicated by E2 in FIG. 8 and the average value of the second sensor data sampled by J5 and J6 in FIG. 9, is output to the host 200. Thus, the host interface 133 can output the first physical quantity PP1, the second physical quantity PP2 and the third physical quantity PP3 at the predetermined sensitivity to the host 200 at the predetermined output rate RP corresponding to the predetermined cycle TP.

In addition, the method according to the present embodiment is not limited to the above, and may be modified by adding other features. For example, although the first sensor 110 is described above as a two-axis sensor, the first sensor 110 may be a three-axis sensor. In addition, for example, when the second sensor 120 is a sensor with higher accuracy than the first sensor 110, the method described above may be combined with a method in which a part of the first sensor data is replaced with the second sensor data. Specifically, for example, as shown in FIG. 10, in the inertial sensor module 100 according to the present embodiment, the first sensor 110 detects a low-accuracy third physical quantity LP3 around the third detection axis, and the second sensor 120 detects a high-accuracy third physical quantity HP3 around the third detection axis. In addition, the processing circuit 130 outputs the high-accuracy third physical quantity HP3 received via the second interface 132 instead of the low-accuracy third physical quantity LP3 received via the first interface 131 to the host 200 via the host interface 133. High accuracy here means that an S/N ratio is high or an error is small. For example, when signal strengths output by the sensor element of the first sensor 110 and the sensor element of the second sensor 120 are the same, a ratio of a noise strength to the signal strength of the second sensor 120 is smaller. Alternatively, a ratio of an error to the signal strength output by the sensor element of the second sensor 120 is smaller than a ratio of an error to the signal strength output by the sensor element of the first sensor 110.

By combining these methods, the first sensor 110 detects the low-accuracy third physical quantity LP3 at the third detection axis with the first sensitivity, and the second sensor 120 detects the high-accuracy third physical quantity HP3 at the third detection axis with the second sensitivity. In addition, the processing circuit 130 outputs a low-accuracy first physical quantity PLP1 at a predetermined sensitivity, a low-accuracy second physical quantity PLP2 at the predetermined sensitivity, and a high-accuracy third physical quantity PHP3 at the predetermined sensitivity to the host 200 via the host interface 133. Thus, the sensor data at a sensitivity unified to the predetermined sensitivity and with improved accuracy at any axis can be output.

Such communication can be implemented by, for example, the following method. For example, the first sensor 110 transmits a low-accuracy first physical quantity LP1, a low-accuracy second physical quantity LP2 and a low-accuracy third physical quantity LP3 as serial data of SPI standard to the first interface 131 via the signal line DOUT1. In addition, the second sensor 120 transmits the high-accuracy third physical quantity HP3 as serial data of SPI standard to the second interface 132 via the signal line DOUT2. The processing circuit 130 performs the arithmetic processing described above on the low-accuracy first physical quantity LP1 and the low-accuracy second physical quantity LP2 in the received first sensor data, and transmits the processed data as the low-accuracy first physical quantity PLP1 at the predetermined sensitivity and the low-accuracy second physical quantity PLP2 at the predetermined sensitivity to the signal line DOUTP via the host interface 133. Further, the processing circuit 130 replaces a low-accuracy third physical quantity PLP3 at a predetermined sensitivity obtained by performing the arithmetic processing described above on the low-accuracy third physical quantity LP3 in the received first sensor data, with the high-accuracy third physical quantity PHP3 at the predetermined sensitivity obtained by performing the arithmetic processing described above, and transmits the high-accuracy third physical quantity PHP3 to the signal line DOUTP via the host interface 133.

Further, for example, the first sensor 110 may be a six-axis sensor. The six-axis sensor is a sensor in which a three-axis physical quantity sensor that can independently detect physical quantities respectively in the X-axis direction, the Y-axis direction, and the Z-axis direction, and a three-axis physical quantity sensor that can independently detect other physical quantities respectively in the X-axis direction, the Y-axis direction, and the Z-axis direction are added. For example, when the first sensor 110 includes a three-axis acceleration sensor and a three-axis angular velocity sensor, the first sensor 110 detects a low-accuracy first angular velocity LG1, a low-accuracy second angular velocity LG2, a low-accuracy third angular velocity LG3, a low-accuracy first acceleration LA1, a low-accuracy second acceleration LA2, and a low-accuracy third acceleration LA3 at the first sensitivity. For example, when it is desired to set an angular velocity in a Z direction to be more accurate than the low-accuracy third angular velocity LG3, the inertial sensor module 100 uses the second sensor 120 as an angular velocity sensor in the Z axis to obtain a high-accuracy third angular velocity HG3 at the second sensitivity. Further, by using the method described above, the host interface 133 may transmit a low-accuracy first angular velocity PLG1, a low-accuracy second angular velocity PLG2, and a high-accuracy third angular velocity PHG3, and a low-accuracy first acceleration PLAT, a low-accuracy second acceleration PLA2, and a low-accuracy third acceleration PLA3 at a predetermined sensitivity to the host 200. A sensor unit including an acceleration sensor and an angular velocity sensor may be referred to as inertial measurement unit (IMU).

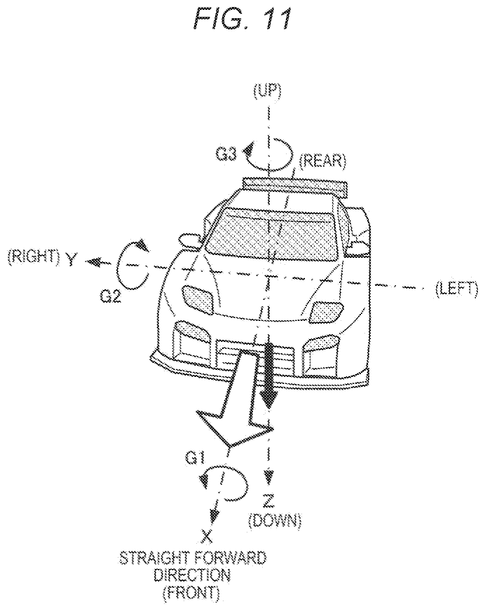

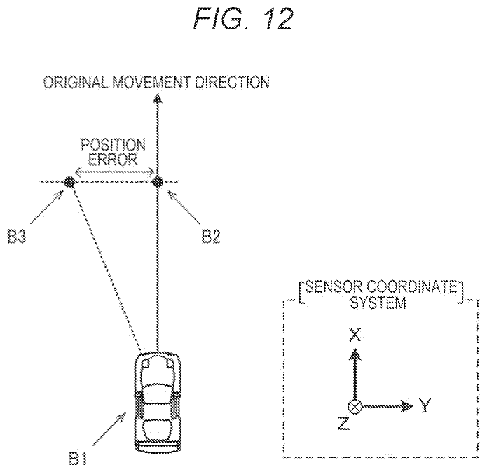

Here, an example will be described with reference to FIGS. 11 and 12 in which the accuracy of the angular velocity at the third detection axis is required to be higher than the accuracy of the angular velocities at the first detection axis and the second detection axis. As described above, the host 200 and the inertial sensor module 100 including the first sensor 110 is provided in the measurement system. The measurement system is fixedly mounted on the moving object described above. FIG. 11 is a diagram illustrating a relation between a moving direction of the four-wheeled vehicle, which is an example of the moving object described above, and coordinate systems of the first sensor 110 and the second sensor 120 provided in the measurement system. Hereinafter, the coordinate systems of the first sensor 110 and the second sensor 120 are simply referred to as sensor coordinate systems. Hereinafter, it is assumed that directions of X axis, Y axis, and Z axis in the coordinate systems of the first sensor 110 and the coordinate systems of the second sensor 120 are the same. The X axis of the sensor coordinate system is set to a front-rear direction of the moving object, and a front direction is set as an X-axis positive direction. In addition, the Y axis of the sensor coordinate system is set to a left-right direction of the moving object, and a right direction is set as a Y-axis positive direction. Further, the Z axis of the sensor coordinate system is set to a direction orthogonal to the X axis and the Y axis, and a down direction of the moving object is set as a Z-axis positive direction. Since the moving object moves in a substantially horizontal plane, an XY plane is regarded as a moving plane of the moving object, and the Z-axis positive direction can be regarded as coincident with the gravity direction. Further, postures of the moving object are expressed by a roll angle around the X axis, a pitch angle around the Y axis, and a yaw angle around the Z axis. In addition, as described above, the moving object moves in the substantially horizontal plane, so that the roll angle corresponds to a tilt in the left-right direction of the moving object, the pitch angle corresponds to a tilt in the front-rear direction of the moving object, and the yaw angle corresponds to a conversion in the moving direction or a direction of the moving object, the roll angle, the pitch angle and the yaw angle are postures. In an inertial navigation arithmetic processing, the postures are calculated by time-integrating an angular velocity, which is an output signal of the first sensor 110 or the like. That is, in FIG. 11, when the first sensor 110 and the second sensor 120 are angular velocity sensors, the roll angle is obtained by time-integrating the first angular velocity G1, the pitch angle is obtained by time-integrating the second angular velocity G2, and the yaw angle is obtained by time-integrating the third angular velocity G3, the first angular velocity G1, the second angular velocity G2 and the third angular velocity G3 are obtained by the measurement system.

FIG. 12 is a diagram illustrating a position error. FIG. 12 shows a diagram of the moving object seen from above, that is, a diagram in the XY plan of the sensor coordinate system. An actual moving direction is indicated by a solid line as an original movement direction. Since the front direction of the moving object is the X-axis positive direction, the actual moving direction is also the X-axis positive direction. A position indicated by B1 is a position of the moving object at a first time t1 and is a known position. A position indicated by B2 is an actual position of the moving object at a second time t2, and a position indicated by B3 is a position calculated by the inertial navigation arithmetic processing using the measurement system, and is the position of the moving object at the second time t2. A distance between the position indicated by B2 and the position indicated by B3 is a position error that is caused by a bias error of an output signal of the first sensor 110 while the moving object moves from the first time t1 to the second time t2. As described above, since the moving object moves in the substantially horizontal plane, this positional displacement is caused by an error of the yaw angle which is a posture. Further, this error of the yaw angle increases with the passage of time. Therefore, it is desirable that the error of the yaw angle is smaller than an error of the roll angle and an error of the pitch angle, in other words, it is desirable that measurement accuracy of the angular velocity around the Z axis is higher than measurement accuracy of the angular velocity around the X axis and measurement accuracy of the angular velocity around the Y axis. In this regard, by applying the method according to the present embodiment, the measurement system can obtain a yaw angle based on the high-accuracy third physical quantity HP3 at the predetermined sensitivity. Accordingly, the position of the moving object or the like can be predicted more appropriately.

In addition, when the six-axis sensor is implemented by the Si-MEMS inertial sensor described above, it is possible to realize size reduction, but it is not possible to obtain sensor data with an accuracy sufficient to satisfy requirements described above in FIG. 10 and the like. On the other hand, when the first sensor 110 is configured such that the six physical quantities described above can be obtained simply by the crystal inertial sensor described above, the high-accuracy sensor data can be obtained, but the size reduction cannot be realized. Therefore, in the present embodiment, it may be set such that the first sensor 110 that is a small six-axis sensor is implemented by the Si-MEMS inertial sensor, and the second sensor 120 is implemented as the crystal inertial sensor to obtain physical quantities only in a direction in which high accuracy is required. Thus, it is possible to provide a physical quantity sensor that achieves both the size reduction and the high accuracy.

Although the above description is made for a case where the third detection axis is the Z axis, the X axis may be the third detection axis. In this case, the Y axis may be the first detection axis, the Z axis may be the second detection axis, or the Z axis may be the first detection axis, the Y axis may be the second detection axis. Similarly, the Y axis may be the third detection axis. In this case, the X axis may be the first detection axis, the Z axis may be the second detection axis, or the Z axis may be the first detection axis, the X axis may be the second detection axis.

As described above, the inertial sensor module according to the present embodiment includes a first sensor, a second sensor, and a processing circuit. The first sensor detects, with a first sensitivity, a first physical quantity at a first detection axis and a second physical quantity at a second detection axis. The second sensor detects, with a second sensitivity different from the first sensitivity, a third physical quantity at a third detection axis with a higher accuracy than the first sensor. The processing circuit performs processing of converting the first physical quantity and the second physical quantity at the first sensitivity and the third physical quantity at the second sensitivity into a first physical quantity, a second physical quantity, and a third physical quantity at a predetermined sensitivity.

Thus, on a device side that requires the first physical quantity, the second physical quantity, and the third physical quantity, the predetermined sensor data whose sensitivity is unified to the predetermined sensitivity can be received without requiring an adjustment to unify the sensitivity.

In addition, the inertial sensor module may further include a first interface that is an interface for the first sensor, a second interface that is an interface for the second sensor, and a host interface that is an interface for the host, and the host interface may output the first physical quantity, the second physical quantity, and the third physical quantity at the predetermined sensitivity to the host.

Thus, transmission and reception of data can be performed with the first sensor, the second sensor and the host. Further, the host interface can output sensor data at unified sensitivity to the host.

The first sensor may input the first physical quantity and the second physical quantity at the first sensitivity to the first interface at a first input rate, the second sensor may input the third physical quantity at the second sensitivity to the second interface at a second input rate different from the first input rate.

Thus, even when the inertial sensor module includes sensors having different input rates, it is possible to output sensor data with unified sensitivity to the host.

Further, the host interface may output the first physical quantity, the second physical quantity, and the third physical quantity at the predetermined sensitivity to the host at a predetermined output rate.

Thus, even when the inertial sensor module includes sensors having different input rates, it is possible to output sensor data with unified output rate and sensitivity to the host.

In addition, the predetermined output rate may be lower than the first input rate and the second input rate.

Thus, the first sensor data and the second sensor data on an input side can be output in synchronization with each other.

Further, the first sensor may detect a low-accuracy third physical quantity around the third detection axis, the second sensor may detect a high-accuracy third physical quantity around the third detection axis, and the processing circuit may output the high-accuracy third physical quantity received via the second interface instead of the low-accuracy third physical quantity received via the first interface to the host via the host interface.

Thus, sensor data at a sensitivity unified to the predetermined sensitivity and with improved accuracy at any axis can be output.

In addition, the first physical quantity may be an angular velocity around the first detection axis, the second physical quantity may be an angular velocity around the second detection axis, and the third physical quantity may be an angular velocity around the third detection axis.

Thus, it is possible to output the angular velocity data with unified sensitivity.

In addition, the first physical quantity may be an acceleration at the first detection axis, the second physical quantity may be an acceleration at the second detection axis, and the third physical quantity may be an acceleration at the third detection axis.

Thus, it is possible to output the acceleration data with unified sensitivity.

Although the present embodiment has been described in detail above, it will be easily understood by a person skilled in the art that a plurality of modifications can be made without substantially departing from the novel matters and effects according to the present disclosure. Therefore, all such modifications are intended to be included within the scope of the present disclosure. For example, a term described at least once together with a different term having a broader meaning or the same meaning in the description or the drawings can be replaced with the different term in any place in the description or the drawings. In addition, all combinations of the present embodiment and the modifications are also included in the scope of the present disclosure. Further, the configurations, operations, and the like of the inertial sensor module are not limited to those described in the present embodiment, and various modifications can be made.

What is claimed is:

1. An inertial sensor module comprising:
a first sensor configured to detect, with a first sensitivity, a first physical quantity at a first detection axis and a second physical quantity at a second detection axis;
a second sensor configured to detect, with a second sensitivity different from the first sensitivity, a third physical quantity at a third detection axis with a higher accuracy than the first sensor; and
a processing circuit configured to perform processing of converting the first physical quantity and the second physical quantity at the first sensitivity and the third physical quantity at the second sensitivity into a first physical quantity, a second physical quantity, and a third physical quantity at a predetermined sensitivity.

2. The inertial sensor module according to claim 1, further comprising:
a first interface that is an interface for the first sensor;
a second interface that is an interface for the second sensor; and
a host interface that is an interface for a host, wherein
the host interface outputs the first physical quantity, the second physical quantity, and the third physical quantity at the predetermined sensitivity to the host.

3. The inertial sensor module according to claim 2, wherein
the first sensor inputs the first physical quantity and the second physical quantity at the first sensitivity to the first interface at a first input rate, and
the second sensor inputs the third physical quantity at the second sensitivity to the second interface at a second input rate different from the first input rate.

4. The inertial sensor module according to claim 3, wherein
the host interface outputs the first physical quantity, the second physical quantity, and the third physical quantity at the predetermined sensitivity to the host at a predetermined output rate.

5. The inertial sensor module according to claim 4, wherein
the predetermined output rate is lower than the first input rate and the second input rate.

6. The inertial sensor module according to claim 2, wherein
the first sensor detects a low-accuracy third physical quantity around the third detection axis,
the second sensor detects a high-accuracy third physical quantity around the third detection axis, and
the processing circuit outputs the high-accuracy third physical quantity received via the second interface instead of the low-accuracy third physical quantity received via the first interface to the host via the host interface.

7. The inertial sensor module according to claim 1, wherein
the first physical quantity is an angular velocity around the first detection axis,
the second physical quantity is an angular velocity around the second detection axis, and
the third physical quantity is an angular velocity around the third detection axis.

8. The inertial sensor module according to claim 1, wherein
the first physical quantity is an acceleration at the first detection axis,
the second physical quantity is an acceleration at the second detection axis, and
the third physical quantity is an acceleration at the third detection axis.
